(19) United States
(12) Patent Application Publication
(10) Pub. No.: US 2016/0088483 A1
(43) Pub. Date: Mar. 24, 2016

(54) NETWORK COMMUNICATION APPARATUS

(71) Applicant: Institute For Information Industry, Taipei (TW)

(72) Inventors: Chi-Hsien KAO, Taipei City (TW); Chi-Ching HUANG, Kaohsiung City (TW); Chingwo MA, New Taipei City (TW)

(21) Appl. No.: 14/530,363

(22) Filed: Oct. 31, 2014

(30) Foreign Application Priority Data
Sep. 23, 2014 (TW) 103132753

(51) Int. Cl. H04W 16/14; H04W 28/06

(52) U.S. Cl. CPC H04W 16/14; H04W 28/06

(57) ABSTRACT

A network communication apparatus is provided. The network communication apparatus includes a Wi-Fi unit, a sampling rate converter, an LTE unit, and a transceiver. The Wi-Fi unit has a plurality of Wi-Fi data, wherein the Wi-Fi data has a Wi-Fi sampling rate. The sampling rate converter processes the Wi-Fi data by converting the sampling rate. The LTE unit has a plurality of LTE data, wherein the LTE data has an LTE sampling rate. The transceiver generates a CPRI basic frame, wherein a first portion of the CPRI basic frame includes a portion of the LTE data and a second portion of the CPRI basic frame includes a portion of the Wi-Fi data.

### PRIORITY

This application claims priority to Taiwan Patent Application No. 103132753 filed on Sep. 23, 2014, which is hereby incorporated by reference in its entirety.

### FIELD

The present invention relates to a network communication apparatus; more particularly, the present invention relates to a network communication apparatus that is adapted to a Cloud Radio Access Network (Cloud RAN) architecture.

### BACKGROUND

With rapid development of science and technologies, wireless network communication technologies have entered the generation of Long Term Evolution (LTE). LTE technologies have the advantages of having a fast transmission rate and being able to support more users. Nevertheless, LTE signals still will be attenuated by buildings so that some areas (e.g., indoor environments) have poor signal qualities. It means that the problem of insufficient signal coverage still exists in the LTE generation. To increase signal coverage, small cells or femtocells have been adopted by many telecommunication operators. In the meantime, Wireless Fidelity (Wi-Fi) technology is another type of wireless network communication technology commonly used nowadays. Through deployments of Wi-Fi access points, another Internet access mechanism can be provided for users.

In order to provide both LTE communication services and Wi-Fi communication services in one area, a user may deploy an LTE cell (e.g., the aforementioned small cell or the femtocell) together with a Wi-Fi access point in this area. For some reasons (e.g., spaces occupied by the cell and the access point), some heterogeneous network integration technologies have integrated the LTE cell and the Wi-Fi access point into one single apparatus.

FIG. 1A illustrates the architecture of a first kind of conventional heterogeneous network system 11. The heterogeneous network system 11 comprises an Evolved Packet Core Network (EPC) 111, two Ethernet routers 115a, 115b and six multi-mode small cells 113a, 113b, 113c, 113d, 113e, 113f. Each of the multi-mode small cells 113a, 113b, 113c, 113d, 113e, 113f has integrated an LTE Base Band Unit (BBU), an LTE Radio Frequency (RF) unit, a Wi-Fi BBU, and a Wi-Fi RF unit therein (i.e., has integrated a small cell and a Wi-Fi access point therein), so both LTE communication services and Wi-Fi communication services can be provided.

The multi-mode small cells 113a, 113b, 113c are connected to the Ethernet router 115a, the Ethernet router 115a is connected to the EPC network 111 via an optic fiber or a digital subscriber line (DSL), and the EPC network 111 is in turn connected to a backhaul network (not shown). Similarly, the multi-mode small cells 113d, 113e, 113f are connected to the Ethernet router 115b, the Ethernet router 115b is connected to the EPC network 111 via an optic fiber or a DSL, and the EPC network 111 is in turn connected to a backhaul network (not shown).

The architecture of the heterogeneous network system 11 has several significant drawbacks. First, integrating an LTE BBU, an LTE RF unit, a Wi-Fi BBU, and a Wi-Fi RF unit into one single apparatus is high cost. Second, the transmission time is too long for operations (e.g., handover operations) that need to exchange messages between different BBUs. The cause of the second drawback is the LTE BBUs and the Wi-Fi BBUs being distributed in the remote multi-mode small cells 113a, 113b, 113c, 113d, 113e, 113f. When messages are exchanged between the BBUs, the BBUs must connect to the EPC network 111 and the messages are then routed to the multi-mode small cells. Due to the long transmission path, a long transmission time is needed. Third, security loopholes may be encountered during data transmission because data is transmitted via the Internet Protocol (IP) network between the Ethernet routers 115a, 115b and the EPC network 111. It means that data may be routed to networks of other telecommunication operators, which increases the risk of information being stolen.

FIG. 1B illustrates the architecture of a second kind of conventional heterogeneous network system 12. The heterogeneous network system 12 comprises an EPC network 121, a femto gateway 127, two Ethernet routers 125a, 125b, and six integrated femto Wi-Fi access points 123a, 123b, 123c, 123d, 123e, 123f. Each of the integrated femto Wi-Fi access points 123a, 123b, 123c, 123d, 123e, 123f has integrated an LTE BBU, an LTE RF unit, a Wi-Fi BBU, and a Wi-Fi RF unit therein (i.e., has integrated a femto cell and a Wi-Fi access point therein), so both LTE communication services and Wi-Fi communication services can be provided.

The integrated femto Wi-Fi access points 123a, 123b, 123c are connected to the Ethernet router 125a, the Ethernet router 125a is connected to the femto gateway 127 via an optic fiber or a DSL, the femto gateway 127 is connected to the EPC network 121, and the EPC network 121 is in turn connected to a backhaul (not shown). Similarly, the integrated femto Wi-Fi access points 123d, 123e, 123f are connected to the Ethernet router 125b, the Ethernet router 125b is connected to the femot gateway 127 via an optic fiber or a DSL, and the femto gateway 127 is connected to the EPC network 121, and the EPC network 121 is in turn connected to a backhaul network (not shown).

Similar to the heterogeneous network system 11, the architecture of the heterogeneous network system 12 also has the drawbacks of high cost and long transmission time. An additional drawback of the heterogeneous network system 12 is the complexity come along with the encryption and decryption operations. Specifically, in order to improve the security, data are encrypted before being transmitted between the femto gateway 127 and the integrated femto Wi-Fi access points 123a, 123b, 123c, 123d, 123e, 123f. Therefore, the femto gateway 127 and the integrated femto Wi-Fi access points 123a, 123b, 123c, 123d, 123e, 123f must perform encryption and decryption operations, which increase the operation complexity.

Although technologies for integrating the LTE communication services and the Wi-Fi communication services have already been provided, they all have significant drawbacks. Accordingly, technologies that integrate the LTE communication services and the Wi-Fi communication services at a low cost and provide an efficient and secure heterogeneous network system are still in an urgent need.

### SUMMARY

An objective of certain embodiments of the present invention includes providing a network communication apparatus, which comprises a Wireless Fidelity (Wi-Fi) unit, a sampling rate converter, a Long Term Evolution (LTE) unit, and a transceiver. The sampling rate converter is electrically connected to the Wi-Fi unit, while the transceiver is electrically connected to the sampling rate converter and the LTE unit. The Wi-Fi unit has a plurality of Wi-Fi data, wherein the Wi-Fi data has a Wi-Fi sampling rate. The sampling rate converter is configured to perform sampling rate conversion on the Wi-Fi data so that the Wi-Fi data have a Common Public Radio Interface (CPRI) sampling rate. The LTE unit has a plurality of LTE data, wherein the LTE data have an LTE sampling rate. The transceiver is configured to generate a CPRI basic frame, wherein a first portion of the CPRI basic frame comprises a portion of the LTE data and a second portion of the CPRI basic frame comprises a portion of the Wi-Fi data.

When the Wi-Fi unit is a Wi-Fi Base Band Unit (BBU), the LTE unit is an LTE BBU, and the transceiver is a radio equipment controller, the network communication apparatus may be used as a Cloud Radio Access Network (Cloud RAN) Base Band Unit (BBU) pool. Furthermore, when the Wi-Fi unit is a Wi-Fi radio frequency (RF) unit, the LTE unit is an LTE RF unit, and the transceiver is a radio equipment, the network communication apparatus may be used as a Remote Radio Head (RRH). When the network communication apparatus is an RRH, the network communication apparatus may further comprises an Ethernet router. The Ethernet router is electrically connected to the radio equipment and has a plurality of Ethernet data. A third portion of the CPRI basic frame comprises a portion of the Ethernet data.

Another objective of certain embodiments of the present invention includes providing a network communication apparatus, which comprises a transceiver, an LTE unit, a sampling rate converter, and a Wi-Fi unit. The transceiver is electrically connected to the LTE unit and the sampling rate converter, while the sampling rate converter is electrically connected to the Wi-Fi unit. The transceiver is configured to receive a plurality of CPRI basic frames at a CPRI sampling rate, retrieve a plurality of LTE data from a first portion of each of the CPRI basic frames, and retrieve a plurality of Wi-Fi data from a second portion of each of the CPRI basic frames. The LTE unit is configured to process the LTE data according to an LTE sampling rate. The sampling rate converter is configured to perform sampling rate conversion on the Wi-Fi data so that the Wi-Fi data have a CPRI sampling rate. The Wi-Fi unit is configured to process the Wi-Fi data according to the Wi-Fi sampling rate.

When the Wi-Fi unit is a Wi-Fi BBU, the LTE unit is an LTE BBU, and the transceiver is a radio equipment controller, the network communication apparatus may be used as a Cloud RAN BBU pool. Furthermore, when the Wi-Fi unit is a Wi-Fi RF unit, the LTE unit is an LTE RF unit, and the transceiver is a radio equipment, the network communication apparatus may be used as an RRH. When the network communication apparatus is an RRH, the network communication apparatus may further comprise an Ethernet router. The Ethernet router is electrically connected to the radio equipment, and has a plurality of Ethernet data. A third portion of the CPRI basic frame comprises a portion of the Ethernet data.

The present invention in certain embodiments provides a heterogeneous network communication apparatus that integrate both the LTE communication services and the Wi-Fi communication services. The CPRI basic frame generated and/or processed by the network communication apparatus comprises both LTE data and Wi-Fi data. Since the data transmitted by the CPRI basic frame are I/Q data, the LTE data and the Wi-Fi data can be transmitted and/or received securely.

Moreover, in certain embodiments of the present invention, the LTE BBU and the LTE RF unit are disposed in different network communication apparatuses, the Wi-Fi BBU and the Wi-Fi RF unit are disposed in different network communication apparatuses, the LTE BBU and the Wi-Fi BBU are integrated in the Cloud RAN BBU pool, and the LTE RF unit and the Wi-Fi RF unit are integrated in the RRH. In other words, a Cloud RAN architecture is adopted in the present invention. Since the present invention separates the BBUs from the RF units and has a plurality of BBUs (i.e., the LTE BBU and the Wi-Fi BBU) integrated into one single network communication apparatus (i.e., the Cloud RAN BBU pool at the backend), transmission path between the BBUs is relatively short and data can be transmitted and/or received efficiently. Additionally, since the RRH does not comprise the LTE BBU and the Wi-Fi BBU and all the LTE BBUs and the Wi-Fi BBUs may be disposed in one single Cloud RAN BBU pool, the network communication system can be deployed at a low cost.

The detailed technology and preferred embodiments implemented for the subject invention are described in the following paragraphs accompanying the appended drawings for people skilled in this field to well appreciate the features of the claimed invention.

### BRIEF DESCRIPTION OF THE DRAWINGS

FIG. 1A depicts an architecture of a first kind of conventional heterogeneous network system 11;

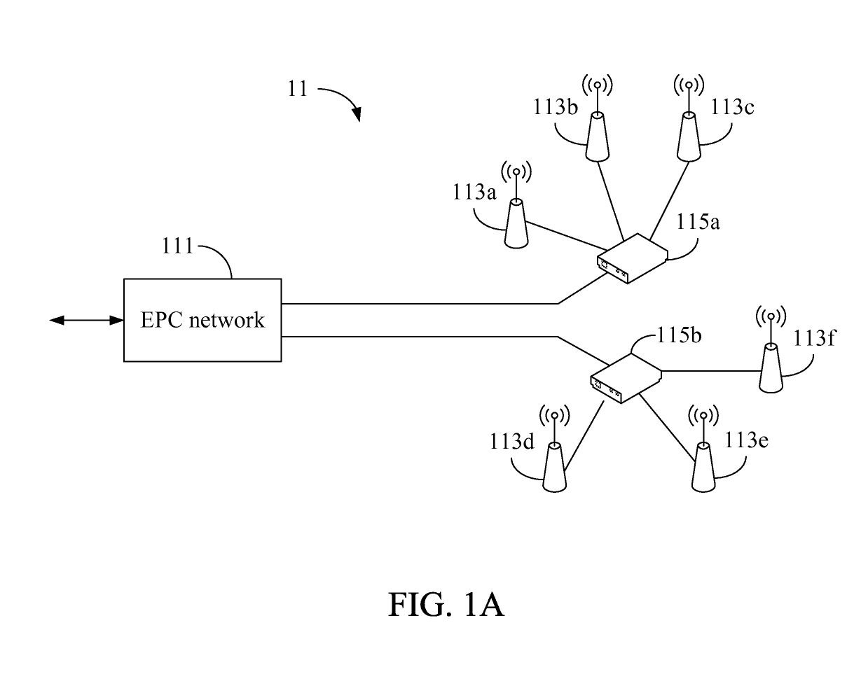

FIG. 1B depicts an architecture of a second kind of conventional heterogeneous network system 12;

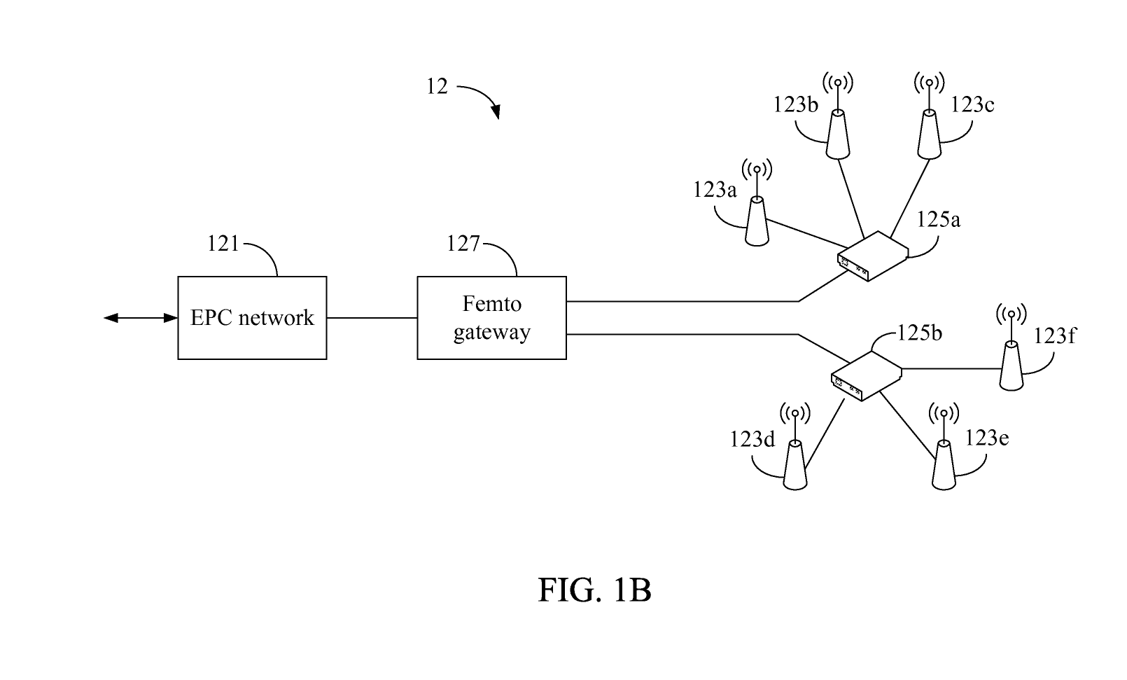

FIG. 2 depicts a schematic view of a network communication system 2 according to a first embodiment of the present invention;

FIG. 3 depicts a schematic view of a network communication system 3 according to a second embodiment of the present invention; and

FIG. 4 depicts a schematic architectural view of an A×C container block.

### DETAILED DESCRIPTION

In the following description, the network communication apparatus of certain embodiments of the present invention will be explained with reference to example embodiments thereof. However, these example embodiments are not intended to limit the present invention to any specific examples, embodiments, environment, applications, or particular implementations described in these embodiments. Therefore, description of these example embodiments is only for purpose of illustration rather than to limit the present invention. It should be appreciated that elements unrelated to the present invention are omitted from depiction in the following embodiments and the attached drawings.

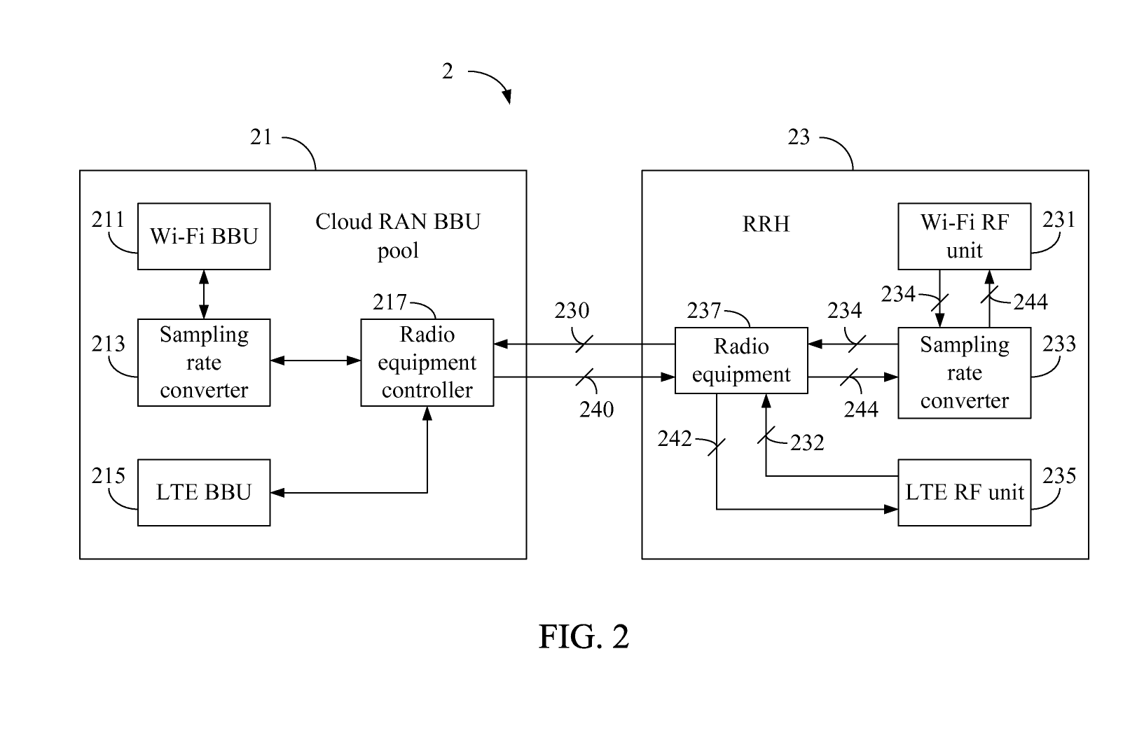

A first embodiment of the present invention is a heterogeneous network communication system 2, a schematic view of which is depicted in FIG. 2. The network communication system 2 comprises two network communication apparatuses, each of the network communication apparatuses comprises a Wireless Fidelity (Wi-Fi) unit, a sampling rate converter, a Long Term Evolution (LTE) unit, and a transceiver. The sampling rate converter is electrically connected to the Wi-Fi unit, while the transceiver is electrically connected to the sampling rate converter and the LTE unit.

Specifically, one of the network communication apparatuses comprised in the network communication system 2 is a Cloud Radio Access Network (Cloud RAN) Base Band Unit (BBU) pool 21, while the other of the network communication apparatuses is a Remote Radio Head (RRH) 23. The Wi-Fi unit, the sampling rate converter, the LTE unit, and the transceiver comprised in the Cloud RAN BBU pool 21 are a Wi-Fi BBU 211, a sampling rate converter 213, an LTE BBU 215, and a radio equipment controller 217 respectively. The Wi-Fi unit, the sampling rate converter, the LTE unit, and the transceiver comprised in the RRH 23 are a Wi-Fi RF unit 231, a sampling rate converter 233, an LTE RF unit 235, and a radio equipment 237 respectively.

A brief description will be made from the perspective of the RRH 23. At some occasions, the LTE RF unit 235 has a plurality of LTE data 232 to be transmitted to the Cloud RAN BBU pool 21, while the Wi-Fi RF unit 231 also has a plurality of Wi-Fi data 234 to be transmitted to the Cloud RAN BBU pool 21. The LTE data 232 has an LTE sampling rate (not shown), while the Wi-Fi data 234 has a Wi-Fi sampling rate (not shown). The present invention does not limit the source of the LTE data 232. For example, the LTE data 232 may be received by the LTE RF unit 235 (if it has the functionalities of an antenna) or by a first antenna (not shown) at the LTE sampling rate. Similarly, the present invention does not limit the source of the Wi-Fi data 234 either. For example, the Wi-Fi data 234 may be received by the Wi-Fi RF unit 231 (if it has the functionalities of an antenna) or a second antenna (not shown) at the Wi-Fi sampling rate. It shall be appreciated that the terms “first” and “second” of the “first antenna” and the “second antenna” are used only for the purpose of distinguishing the two antennas from each other but not for implying any sequence.

The sampling rate converter 233 firstly performs sampling rate conversion on the Wi-Fi data 234 to convert the Wi-Fi data 234 into a Common Public Radio Interface (CPRI) sampling rate (not shown). Then, the radio equipment 237 generates at least one CPRI basic frame 230 in such a way that a first portion (not shown) of each of the CPRI basic frames 237 comprises a portion of the LTE data 232 and a second portion (not shown) of the CPRI basic frame 237 comprises a portion of the Wi-Fi data 234. The first portion and the second portion are predetermined positions. It shall be appreciated that the terms “first” and “second” of the “first portion” and the “second portion” are used only for the purpose of distinguishing the two portions from each other but not for implying any sequence. Next, the radio equipment 237 transmits the CPRI basic frames 230 to the Cloud RAN BBU pool 21. For example, the radio equipment 237 may transmit the CPRI basic frames 230 to the Cloud RAN BBU pool 21 via an optic fiber.

At some other occasions, the radio equipment 237 receives a plurality of CPRI basic frames 240 from the Cloud RAN BBU pool 21 at a CPRI sampling rate. For example, the radio equipment 237 may receive the CPRI basic frames 240 via an optic fiber.

The radio equipment 237 further retrieves a plurality of LTE data 242 from a first portion (not shown) of each of the CPRI basic frames 240 and retrieves a plurality of Wi-Fi data 244 from a second portion (not shown) of each of the CPRI basic frames 240. Similarly, the first portion and the second portion described above are predetermined positions. The sampling rate converter 233 performs sampling rate conversion on the Wi-Fi data 244 so that the Wi-Fi data 244 has a Wi-Fi sampling rate. Then, the Wi-Fi RF unit 231 processes the Wi-Fi data 244 according to the Wi-Fi sampling rate. For example, the Wi-Fi RF unit 231 (if it has the functionalities of an antenna) transmits the Wi-Fi data 244 directly at the Wi-Fi sampling rate or transmits the Wi-Fi data 244 via the second antenna (not shown). The LTE RF unit 235 processes the LTE data 242 according to the LTE sampling rate. For example, the LTE RF unit 235 (if it has the functionalities of an antenna) transmits the LTE data 242 directly at the LTE sampling rate or transmits the LTE data 242 via the first antenna (not shown).

According to the essence of the present invention, the operations performed by the Cloud RAN BBU pool 21 are similar to those performed by the RRH 23. Briefly speaking, when the Wi-Fi BBU 211 has a plurality of Wi-Fi data (not shown) to be transmitted to the RRH 23 and the LTE BBU 215 has a plurality of LTE data (not shown) to be transmitted to the RRH 23, the sampling rate converter 213 and the radio equipment controller 217 perform operations similar to those performed by the sampling rate converter 233 and the radio equipment 237. Hence, the details are not repeated herein. Moreover, when a plurality of CPRI basic frames (not shown) is received by the radio equipment controller 217 from the RRH 23 at the CPRI sampling rate, the radio equipment controller 217 performs operations similar to those performed by the sampling rate converter 233 and the radio equipment 237. Afterwards, the Wi-Fi BBU 211 processes the retrieved Wi-Fi data according to the Wi-Fi sampling rate and the LTE BBU 215 processes the retrieved LTE data according to the LTE sampling rate. The details are not repeated herein.

Although the network communication system 2 of this embodiment comprises two network communication apparatuses (one of the network communication apparatuses is the Cloud RAN BBU pool and the other is the RRH 23), the present invention has no limitation on the number of network communication apparatuses in a network communication system. In other embodiments, the network communication system may comprise more than two network communication apparatuses. Moreover, in other embodiments, one radio equipment controller 217 may correspond to a plurality of radio equipments 237. That is, one Cloud RAN BBU pool may correspond to a plurality of RRHs.

According to the above descriptions of this embodiment, the LTE BBU 215 and the LTE RF unit 235 are separately disposed in different network communication apparatuses, the Wi-Fi BBU 211 and the Wi-Fi RF unit 231 are separately disposed in different network communication apparatuses, the LTE BBU 215 and the Wi-Fi BBU 211 are integrated in the Cloud RAN BBU pool 21, and the LTE RF unit 235 and the Wi-Fi RF unit 231 are integrated in the RRH 23. In other words, a Cloud RAN architecture is adopted in the present invention to integrate the LTE communication services and the Wi-Fi communication services. Since the present invention separates the BBUs from the RF units and has a plurality of BBUs (i.e., the LTE BBU and the Wi-Fi BBU) integrated into one single Cloud RAN BBU pool, message transmission path between the BBUs is relatively short and data can be transmitted and/or received efficiently.

Furthermore, since the RRH does not comprise the LTE BBU and the Wi-Fi BBU and all the LTE BBUs and the Wi-Fi BBUs are integrated into one single Cloud RAN BBU pool, both the RRH and the Cloud RAN BBU pool can be deployed at a low cost. When the network communication system 2 comprises more than two RRHs, the BBUs corresponding to these RRHs can still be disposed in this single Cloud RAN BBU pool. In such case, the reduced cost is more significant.

Based on the architecture of this embodiment, the CPRI basic frames generated and/or processed by the Cloud RAN BBU pool 21 and the RRH 23 comprise both the LTE data and the Wi-Fi data. Hence, it is ensured that LTE communication services and Wi-Fi communication services can be provided together.

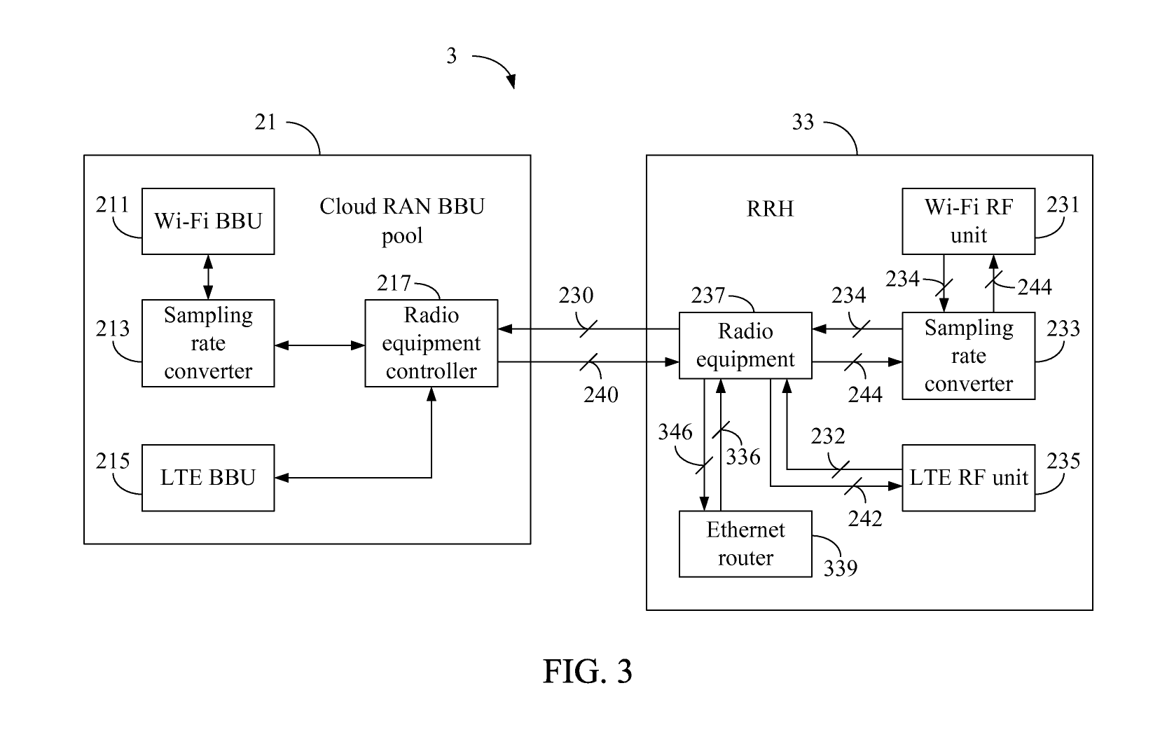

A second embodiment of the present invention is a heterogeneous network communication system 3 and a schematic view of which is depicted in FIG. 3. The network communication system 3 comprises two network communication apparatuses, wherein one of which is a Cloud RAN BBU pool 21 and the other of which is an RRH 33. The units comprised in the Cloud RAN BBU pool 21 and the operations performed by each of the units are the same as those described in the first embodiment; hence, the descriptions are not repeated herein. The RRH 33 comprises a Wi-Fi RF unit 231, a sampling rate converter 233, an LTE RF unit 235, a radio equipment 237, and an Ethernet router 339, wherein the Ethernet router 339 is electrically connected to the radio equipment 237. The operations performed by the Wi-Fi RF unit 231, the sampling rate converter 233, the LTE RF unit 235, and the radio equipment 237 are the same as those described in the first embodiment; hence, the descriptions are not repeated herein. Since most operations performed by the network communication system 3 are the same as those of the network communication system 2, only the differences between the two embodiments are detailed hereinbelow.

In this embodiment, at some occasions, the Wi-Fi RF unit 231 has Wi-Fi data 234 to be transmitted to the Cloud RAN BBU pool 21, the LTE RF unit 235 has LTE data 232 to be transmitted to the Cloud RAN BBU pool 21, and the Ethernet router 239 has a plurality of Ethernet data 336 to be transmitted.

The sampling rate converter 233 and the radio equipment 237 perform operations identical to those described in the first embodiment. This embodiment differs from the first embodiment in the content of the at least one CPRI basic frame 230 generated by the radio equipment 237. In this embodiment, a first portion (not shown) of each of the CPRI basic frames 230 comprises a portion of the LTE data 232, a second portion (not shown) of each of the CPRI basic frames 230 comprises a portion of the Wi-Fi data 234, and a third portion (not shown) of each of the CPRI basic frames 230 comprises a portion of the Ethernet data 336. The first portion, the second portion, and the third portion are predetermined positions. It should be appreciated that the terms “first,” “second,” and “third” of the “first portion,” the “second portion,” and the “third portion” are used only for the purpose of distinguishing the three portions from each other but not for implying any sequence.

Another difference of this embodiment from the first embodiment is the way in which the radio equipment 237 processes the CPRI basic frames 240 received from the Cloud RAN BBU pool 21. In this embodiment, the radio equipment 237 retrieves a plurality of LTE data 242 from a first portion (not shown) of each of the CPRI basic frames 240, retrieves a plurality of Wi-Fi data 244 from a second portion (not shown) of each of the CPRI basic frames 240, and retrieves a plurality of Ethernet data 346 from a third portion (not shown) of each of the CPRI basic frames 240. The first portion, the second portion, and the third portion are predetermined positions. Then, the Ethernet router 339 processes these Ethernet data 346, for example, transmits these Ethernet data 346.

According to the above descriptions, this embodiment integrates not only the LTE communication services and the Wi-Fi communication services but also the Ethernet services. Since the operations performed by the network communication system 3 is similar to those performed by the network communication system 2, the network communication system 3 also has the advantages described in the first embodiment. In the meantime, the network communication system 2 provides more diversified network communication services.

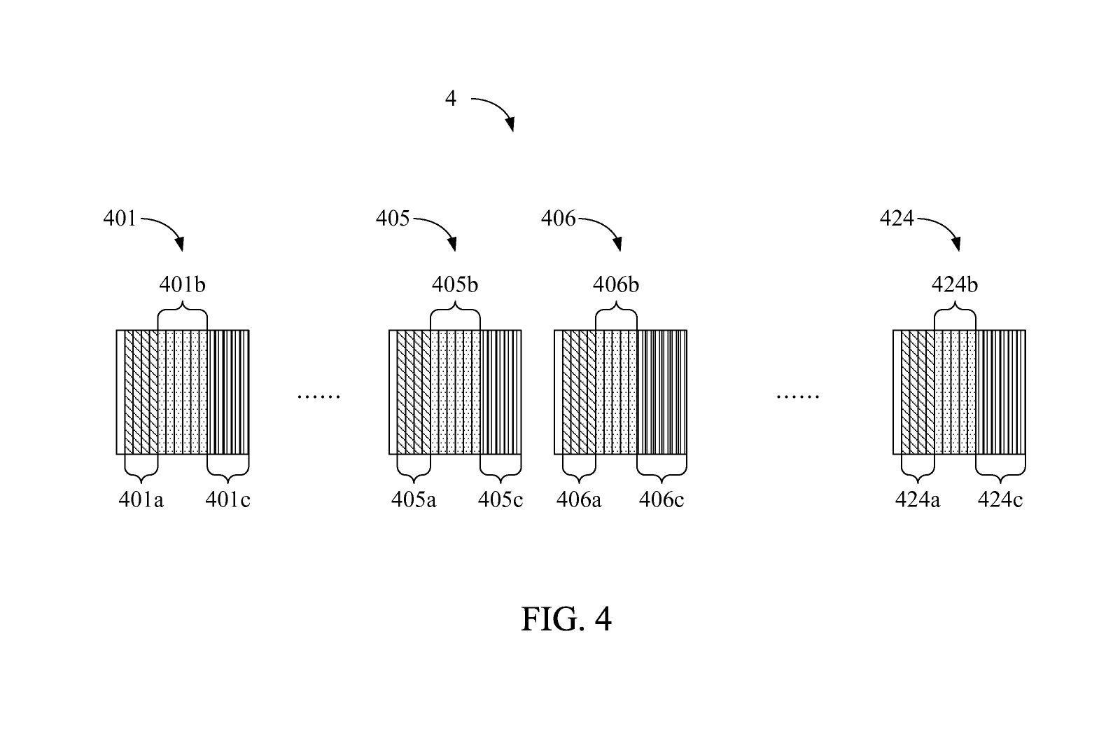

A third embodiment of the present invention is shown in FIG. 3 and FIG. 4. In this embodiment, the LTE and Wi-Fi in the network communication system 3 follow specific network communication standards and specifications. The specifications of the LTE provide several bandwidths, including 1.4 Mega Hertz (MHz), 3 MHz, 5 MHz, 10 MHz, 15 MHz, and 20 MHz. Different bandwidths correspond to different sampling rates. In this embodiment, the bandwidth of the LTE is 10 MHz and the corresponding LTE sampling rate is 15.36 MHz. In this embodiment, the Wi-Fi follows the IEEE 802.11g standard and the Wi-Fi sampling rate is 20 MHz. The CPRI basic frames are transmitted and/or received via an optic fiber at a line rate of 4×. Furthermore, in this embodiment, the radio equipment controller 217 of the Cloud RAN BBU pool 21 is connected to the radio equipment 237 of the RRH 23 via an optic fiber (not shown).

Please refer to FIG. 4, which depicts the format of the frames transmitted between the Cloud RAN BBU unit 21 and the RRH 33. Specifically, FIG. 4 depicts the architecture of an A×C container block 4. The A×C container block 4 comprises 24 CPRI basic frames 401, . . . , 405, 406, . . . , 424. For the A×C container block 4, each of the CPRI basic frames 401, . . . , 405, 406, . . . , 424 has a serial number. For example, serial numbers of the CPRI basic frames 401 and 406 within the A×C container block 4 are respectively 1 and 6. Each of the CPRI basic frames 401, . . . , 405, 406, . . . , 424 comprises sixteen A×C containers. In FIG. 4, each A×C container is represented by a rectangle. Each of the A×C containers has a serial number within the CPRI basic frame that it belongs. Taking the CPRI basic frame 401 as an example, the serial numbers of the sixteen A×C containers are numbered in sequence from the left to the right and starting from 0.

In this embodiment, each of the Wi-Fi data 234 and 244 is an I/Q data, each of the LTE data 232 and 242 is an I/Q data, and the resolution of each I/Q data are 16 bits. Since the line rate of the CPRI basic frames is 4×, the size of each A×C container is 32 bits. Therefore, each of the A×C containers can contain one I data and one Q data.

Similar to the first embodiment and the second embodiment, the first portion, the second portion, and the third portion of each of the CPRI basic frames 401, . . . , 405, 406, . . . , 424 are allocated to LTE data, Wi-Fi data, and Ethernet data respectively in this embodiment. It should be appreciated that the first portion, the second portion, and the third portion are predetermined positions. It should be appreciated that the terms “first,” “second,” and “third” of the “first portion,” “the second portion,” and “the third portion” are used only for the purpose of distinguishing the three portions from each other but not for implying any sequence. Since the first portion, the second portion, and the third portion are predetermined, the radio equipment 237 and the radio equipment controller 217 have the knowledge of the portions within a CPRI basic frame that the LTE data, the Wi-Fi data, and/or the Ethernet data can be correctly retrieved and/or placed.

As mentioned, the LTE and Wi-Fi of the network communication system 3 follow specific network communication standards and specifications. Hence, the allocation scheme of the first portion and the second portion in each of the CPRI basic frames must be specially designed. When deciding the first portion and the second portion, the LTE sampling rate (15.36 MHz), the Wi-Fi sampling rate (20 MHz), and the sampling rate (3.84 MHz) of the CPRI basic frames must be taken into consideration. Before deciding the first portion and the second portion, the number of A×C containers that should be allocated to the LTE data and the number of A×C containers that should be allocated to the Wi-Fi data in one CPRI basic frame may be decided first. For example, for a certain kind of data (e.g., the LTE data or the Wi-Fi data), the following four formulas may be used to calculate the number of A×C containers that should be allocated to this kind of data in each of the CPRI basic frames and the number of A×C containers that should be adjusted in each of the A×C container blocks:

$$K = \frac{LCM ( {f}_{s} , {f}_{c} )}{{f}_{s}}$$

$$S = \frac{LCM ( {f}_{s} , {f}_{c} )}{{f}_{c}}$$

$${N}_{c} = ⌈ \frac{{N}_{A} S}{K} ⌉$$

$${N}_{v} = {N}_{c} K \text{-} {N}_{A} S$$

In the above four formulas, the parameter f_{c} represents a sampling rate (3.84 MHz) of the CPRI basic frame, the parameter fₛ represents a sampling rate of a certain kind of data (when LTE-related data is calculated, fₛ represents the LTE sampling rate; and when Wi-Fi related data are calculated, fₛ represents the Wi-Fi sampling rate), the function LCM represents the least common multiple, and the parameters K and S are used to represent a multiple obtained by dividing one value by another value. Furthermore, A×C is the unit of individual antenna, the parameter N_{A} represents the number of A×Cs in one A×C group. In this embodiment, one A×C group has a Single-Input Single Output (SISO), so the value of N_{A} is 1. Moreover, the parameter N_{c} represents the number of A×C containers that should be allocated to this kind of data in each of the CPRI basic frames on average. The parameter Nᵥ represents the number of A×C containers that should be additionally deducted from each of the A×C container blocks when the allocation is performed according to N_{c}.

If the LTE data is calculated according to the above four formulas, the value of N_{c} is 4 and the value of Nᵥ is 0. It represents that four A×C containers should be allocated to the LTE data in each of the CPRI basic frames on average and it is unnecessary for an A×C container block to adjust any number of A×C containers. If the Wi-Fi data is calculated according to the above four formulas, the value of N_{c} is 6 and the value of Nv is 19. It represents that six A×C containers should be allocated to the Wi-Fi data in each of the CPRI basic frames on average and. However, based on the aforesaid allocation scheme, nineteen A×C containers must be deducted to conform to the Wi-Fi sampling rate. After the value of N_{c} and the value of Nᵥ for the LTE data and the value of N_{c} and the value of Nᵥ for the Wi-Fi data are obtained through calculation, the first portion and the second portion of each of the CPRI basic frames 401, . . . , 405, 406, . . . , 424 can be decided and the remaining portion may be used as the third portion.

In this embodiment, in an A×C container block 4, the first five CPRI basic frames (i.e., CPRI basic frames 401, . . . , 405) have the same arrangement of the first portion, the second portion, and the third portion, while the last nineteen CPRI basic frames (i.e., CPRI basic frames 406, . . . , 424) have the same arrangement of the first portion, the second portion, and the third portion.

For each of the first five CPRI basic frames (i.e., CPRI basic frames 401, . . . , 405), four A×C containers are allocated to LTE data, six A×C containers are allocated to the Wi-Fi data, and five A×C containers are allocated to the Ethernet data. For example, for each of the CPRI basic frames 401, . . . , 405, the first to the fourth A×C containers may be used as the first portion (e.g., a first portion 401a of the CPRI basic frame 401 and a first portion 405a of the CPRI basic frame 405 shown in FIG. 4), the fifth to the ninth A×C containers may be used as the second portion (e.g., a second portion 401b of the CPRI basic frame 401 and a second portion 405b of the CPRI basic frame 405 shown in FIG. 4), and the eleventh to the fifteenth A×C containers may be used as the third portion (e.g., a third portion 401c of the CPRI basic frame 401 and a third portion 405c of the CPRI basic frame 405 shown in FIG. 4).

For each of the last nineteen CPRI basic frames (i.e., CPRI basic frames 406, . . . , 424), four A×C containers are allocated to the LTE data, five A×C containers are allocated to the Wi-Fi data, and six A×C containers are allocated to the Ethernet data. It should be appreciated that only five A×C containers in each of the last nineteen CPRI basic frames are allocated to the Wi-Fi data because the value of Nᵥ that is obtained through calculation for the Wi-Fi data is 19. Then, the arrangement scheme of the first portion, the second portion, and the third portion in each of the last nineteen CPRI basic frames will be illustrated. For example, for each of the CPRI basic frames 406, . . . , 424, the first to the fourth A×C containers thereof may be used as the first portion (e.g., a first portion 406a of the CPRI basic frame 406 and a first portion 424a of the CPRI basic frame 424 shown in FIG. 4), the fifth to the ninth A×C containers thereof may be used as the second portion (e.g., a second portion 406b of the CPRI basic frame 406 and a second portion 424b of the CPRI basic frame 424 shown in FIG. 4), and the tenth to the fifteenth A×C containers thereof may be used as the third portion (e.g., a third portion 406c of the CPRI basic frame 406 and a third portion 424c of the CPRI basic frame 424 shown in FIG. 4).

As described above, the radio equipment 237 and the radio equipment controller 217 have the knowledge of the first portion, the second portion, and the third portion in each of the CPRI basic frames 401, . . . , 405, 406, . . . , 424. When there is a need in generating or processing a CPRI basic frame, the radio equipment 237 or the radio equipment controller 217 determines a first portion, a second portion, and a third portion of the CPRI basic frame according to a serial number of the CPRI basic frame in the A×C container block. For example, when the radio equipment 237 learns that it is the fifth CPRI basic frame 405 in the A×C container block to be generated, the radio equipment 237 can determine the first portion 405a, the second portion 405b, and the third portion 405c of the fifth CPRI basic frame 405. As another example, when the radio equipment 237 learns that it is the sixth CPRI basic frame 406 in the A×C container block to be processed, the radio equipment 237 can determine the first portion 406a, the second portion 406b, and the third portion 406c of the sixth CPRI basic frame 406.

It shall be appreciated that the arrangement scheme of the first portion, the second portion, and the third portion described above are only for purpose of illustration rather than to limit the protection scope of the present invention. In other words, in other embodiments, the first portion, the second portion, and the third portion may be arranged at different positions in the CPRI basic frames.

It shall also be appreciated that this embodiment is used to describe the arrangement schemes of the first portion, the second portion, and the third portion in each of the CPRI basic frames when the LTE and the Wi-Fi in the network communication system 3 follow specific network communication standards and specifications. Other operations of the RRH 33 and the Cloud RAN BBU pool 21 are the same as those of the aforesaid embodiments, and will not be further described herein.

Next, it will be proved that the allocation schemes of the first portion, the second portion, and the third portion in the CPRI basic frames 401, . . . , 405, 406, . . . , 424 can surely provide the LTE sampling rate (15.36 MHz in this embodiment) and the Wi-Fi sampling rate (20 MHz in this embodiment). Specifically, since the sampling rate of the CPRI basic frames is 3.84 MHz and four A×C containers are allocated to the LTE data in each of the CPRI basic frames 401, . . . , 405, 406, . . . , 424, the LTE sampling rate can surely reach 15.36 MHz (i.e., 3.84 MHz×4=15.36 MHz). Furthermore, since six A×C containers are allocated to the Wi-Fi data in each of the CPRI basic frames 401, . . . , 405 and five A×C containers are allocated to the Wi-Fi data in each of the CPRI basic frames 406, . . . , 424, the Wi-Fi sampling rate can surely reach 20 MHz (i.e.,

$$3.84 MHz \times \frac{( 6 \times 5 + 5 \times 19 )}{( 5 + 19 )} = 20 MHz ) .$$

Furthermore, since five A×C containers are allocated to the Ethernet data in each of the CPRI basic frames 401, . . . , 405 and six A×C containers are allocated to the Ethernet data in each of the CPRI basic frames 406, . . . , 424, the Ethernet data rate can reach up to 711.68 Mbps (i.e.,

$$32 bits \times 3.84 MHz \times \frac{( 5 \times 5 + 6 \times 19 )}{( 5 + 19 )} = 711.68 Mbps ) .$$

In addition to the above operations, the third embodiment can also execute all the operations and functions described in the first embodiment and the second embodiment. How the third embodiment executes these operations and functions will be readily appreciated by those of ordinary skill in the art based on the first embodiment and the second embodiment, and thus will not be further described again.

According to the above descriptions, the present invention adopts the Cloud RAN architecture to integrate the LTE communication services and the Wi-Fi communication services. Specifically, in the present invention, the LTE BBU and the LTE RF unit are separately disposed in different network communication apparatuses, the Wi-Fi BBU and the Wi-Fi RF unit are separately disposed in different network communication apparatuses, the LTE BBU and the Wi-Fi BBU are integrated in the Cloud RAN BBU pool, and the LTE RF unit and the Wi-Fi RF unit are integrated in the RRH 23. Since the present invention separates the BBUs from the RF units and has a plurality of BBUs (i.e., the LTE BBU and the Wi-Fi BBU) integrated into one single Cloud RAN BBU pool, the message transmission path between the BBUs is relatively short and data can be transmitted and/or received efficiently. Additionally, Since the RRH does not comprise the LTE BBU and the Wi-Fi BBU and all the LTE BBUs and the Wi-Fi BBUs may be disposed in a single Cloud RAN BBU pool, the network communication system can be deployed at a low cost.

Moreover, the LTE data, the Wi-Fi data, and even the Ethernet data are transmitted between the RRH and the Cloud RAN BBU pool via the CPRI basic frames. In other words, the CPRI basic frames generated and/or processed by the RRH and the Cloud RAN BBU pool comprise the LTE data, the Wi-Fi data, and even the Ethernet data at the same time. Since the data transmitted by the CPRI basic frame is I/Q data, the LTE data and the Wi-Fi data can be transmitted or/and received securely.

The above disclosure is related to the detailed technical contents and inventive features thereof. People skilled in this field may proceed with a variety of modifications and replacements based on the disclosures and suggestions of the invention as described without departing from the characteristics thereof. Nevertheless, although such modifications and replacements are not fully disclosed in the above descriptions, they have substantially been covered in the following claims as appended.

What is claimed is:

1. A network communication apparatus, comprising:
a Wireless Fidelity (Wi-Fi) unit, having a plurality of Wi-Fi data, wherein the Wi-Fi data has a Wi-Fi sampling rate;
a sampling rate converter, being electrically connected to the Wi-Fi unit and configured to perform sampling rate conversion on the Wi-Fi data so that the Wi-Fi data have a Common Public Radio Interface (CPRI) sampling rate;
a Long Term Evolution (LTE) unit, having a plurality of LTE data, wherein the LTE data have an LTE sampling rate; and
a transceiver, being electrically connected to the sampling rate converter and the LTE unit and configured to generate a CPRI basic frame, wherein a first portion of the CPRI basic frame comprises a portion of the LTE data and a second portion of the CPRI basic frame comprises a portion of the Wi-Fi data.

2. The network communication apparatus of claim 1, wherein the Wi-Fi unit is a Wi-Fi Base Band Unit (BBU), the LTE unit is an LTE BBU, and the transceiver is a radio equipment controller.

3. The network communication apparatus of claim 1, wherein the Wi-Fi unit is a Wi-Fi radio frequency (RF) unit, the LTE unit is an LTE RF unit, and the transceiver is a radio equipment.

4. The network communication apparatus of claim 3, wherein the LTE RF unit receives the LTE data from a first antenna and the Wi-Fi RF unit receives the Wi-Fi data from a second antenna.

5. The network communication apparatus of claim 3, further comprising:
an Ethernet router, being electrically connected to the radio equipment and having a plurality of Ethernet data;
wherein a third portion of the CPRI basic frame comprises a portion of the Ethernet data.

6. The network communication apparatus of claim 1, wherein the transceiver determines the first portion and the second portion according to a serial number of the CPRI basic frame in an A×C container block.

7. The network communication apparatus of claim 5, wherein the transceiver determines the first portion, the second portion, and the third portion according to a serial number of the CPRI basic frame in an A×C container block.

8. The network communication apparatus of claim 1, wherein the transceiver transmits the CPRI basic frame to another network communication apparatus via an optic fiber.

9. The network communication apparatus of claim 1, wherein each of the Wi-Fi data is an I/Q data and each of the LTE data is an I/Q data.

10. A network communication apparatus, comprising:
a transceiver, being configured to receive a plurality of CPRI basic frames at a CPRI sampling rate, retrieve a plurality of LTE data from a first portion of each of the CPRI basic frames, and retrieve a plurality of Wi-Fi data from a second portion of each of the CPRI basic frames;
an LTE unit, being electrically connected to the transceiver and configured to process the LTE data according to an LTE sampling rate;
a sampling rate converter, being electrically connected to the transceiver and configured to perform sampling rate conversion on the Wi-Fi data so that the Wi-Fi data have a Wi-Fi sampling rate; and
a Wi-Fi unit, being electrically connected to the sampling rate converter and configured to process the Wi-Fi data according to the Wi-Fi sampling rate.

11. The network communication apparatus of claim 10, wherein the Wi-Fi unit is a Wi-Fi BBU, the LTE unit is an LTE BBU, and the transceiver is a radio equipment controller.

12. The network communication apparatus of claim 10, wherein the Wi-Fi unit is a Wi-Fi RF unit, the LTE unit is an LTE RF unit, and the transceiver is a radio equipment.

13. The network communication apparatus of claim 12, wherein the LTE RF unit transmits the LTE data via a first antenna at the LTE sampling rate and the Wi-Fi RF unit transmits the Wi-Fi data via a second antenna at the Wi-Fi sampling rate.

14. The network communication apparatus of claim 12, wherein the radio equipment further retrieves a plurality of Ethernet data from a third portion of each of the CPRI basic frames, and the network communication apparatus further comprises:
an Ethernet router, being electrically connected to the radio equipment and configured to transmit the Ethernet data.

15. The network communication apparatus of claim 10, wherein the transceiver determines the first portion and the second portion according to a serial number of the CPRI basic frame in an A×C container block.

16. The network communication apparatus of claim 14, wherein the transceiver determines the first portion, the second portion, and the third portion according to a serial number of the CPRI basic frame in an A×C container block.

17. The network communication apparatus of claim 10, wherein the transceiver receives the CPRI basic frames from another network communication apparatus via an optic fiber.

18. The network communication apparatus of claim 10, wherein each of the Wi-Fi data is an I/Q data and each of the LTE data is an I/Q data.
